(19) United States
(12) Patent Application Publication
(10) Pub. No.: US 2009/0295570 A1
(43) Pub. Date: Dec. 3, 2009

(54) Consumer Device Locator using Receiver embedded in Battery

(75) Inventors: Gregory Robert Simon, San Francisco, CA (US); Manjirnath Chatterjee, San Francisco, CA (US)

Correspondence Address: MANJIRNATH A CHATTERJEE, 111 GILBERT #2, SAN FRANCISCO, CA, 94103, US

(73) Assignees: Gregory Robert Simon, San Francisco, CA (US); Manjirnath Chatterjee, San Francisco, CA (US)

(21) Appl. No.: 12/129,697

(22) Filed: May 30, 2008

(51) Int. Cl. G08B 1/08

(52) U.S. Cl. 340/539.32

(57) ABSTRACT

Consumer electronics devices such as remote controls, toys, and other handheld battery powered electronics are often misplaced. The present invention embeds a locating device in the battery for such devices such that when a signal is sent from a wireless transmitter, ultrasonic transmitter, or via human sounds such as clapping, whistling, and speaking or the like, the battery beeps to make the lost device findable. Further enhancements allow for multiple families of devices to be tracked and located, and even communicate battery status back to the user or transmitting device.

### BACKGROUND OF THE INVENTION

1. Field of the Invention

The invention relates to object location devices such as those in which an individual presses a button on a transmitter or creates a noise in which a receiver located in the object to be found responds with an alarm signal. The individual can create such a noise via clapping or voice or they can use a transmitter apparatus to emit a signal which can be acoustic, RF, or light by which the receiver is signaled.

2. Prior Art

U.S. Pat. No. 5,493,618, “Method and apparatus for activating switches in response to different acoustic signals” by Stevens et. al, is a device popularly known as “The Clapper”. In this device an acoustic signal (the “clap”) is sent by the user to a suitably configured listening circuit which is configured to turn on a wall switch based AC circuit relay. This enables the user to turn or off a AC load, such as lamp without going near the controlled device. While this permits the use the ability to control the device with a clapping motion it does not help find where the receiver circuit is nor can it be used to find battery operated devices.

U.S. Pat. No. 6,188,986, “Voice activated switch method and apparatus” by Matulich et.al. teaches that we can use the human voice to turn on or off AC appliances. However this limits the use to control of appliances and does not provide inherent location finding ability of the receiver circuit.

The next several patents depict circuits which can be used for object location finding, including finding lost remote controls and the like but they don't provide the utility of the present invention in a few key ways. The present invention embeds the receiver circuitry with the battery so that it can be moved from device to device. The present invention also allows simple pairing to create multiple classes of device under user control such that the user can create classes of devices to be found rather then being limited to factory configurations.

U.S. Pat. No. 6,674,364 “Object finder” Holbrook et. al shows how to use RF to cause device to make a beep or flash a light to make it findable. However this is tied to embedding the receiver in a given device rather than the flexibility afforded by the present invention's use of a combined battery-receiver and it does not have the pairing capability of some embodiments of the present invention.

U.S. Pat. No. 4,101,873 “Device to locate commonly misplaced objects” by Anderson, uses RF to find objects which emit a beep and includes different classes of objects. However, like U.S. Pat. No. 6,674,364 it offers neither the flexibility of the combined battery receiver or the end user class pairing creation capability.

U.S. Pat. No. 6,788,199 “Article locator system” by Crabtree et al., uses a feedback system to find the distance from the article to the transmitting device. This relies on special circuits in the transmitter and article to be located to cooperate in calculating the distance. In addition it does not offer the flexibility of the present invention in the battery tie in so it is limited to devices (remote controls and the like) which implement such a system.

U.S. Pat. No. 4,476,469 “Means for assisting in locating an object” by Lander—includes means for finding an object using a feedback mechanism but does not integrate the apparatus in to a battery though it is mentioned that the receiver must be powered by a small battery.

U.S. Pat. No. 5,945,918 “Apparatus and method for locating a remote control unit” by McGonigal et al—builds a transmitter in the TV to find a remote control. This ties implementation of the transmitter device to a television or similar device and in addition does not include multi object class based pairing.

U.S. Pat. No. 5,686,891 “System for locating an object” by Sacca et al, shows a transmitter in a device (VCR CD player or the like) and receiver in the remote control along with a long duty cycle. This shows how power consumption in the receiver circuit can be reduced however it does not include the flexibility of quickly changing devices which have the finding capability nor does it provide for multiclass pairing capability.

U.S. Pat. No. 5,642,095 “Alarm for a card shaped object” by Cook et al—shows a tracking system for card shaped objects but doesn't include the battery tie in or the multiclass capability.

U.S. Pat. No. 5,859,585 “Pacifier locating system” by Fleming—shows a system for tracking pacifiers where the electronics are in the bulb of the pacifier. This locks uses of this invention to baby pacifiers and does not provide for multiclass capability.

U.S. Pat. No. 6,891,471 “Expandable Object Tracking System” Yuen et al—provides for object tracking rather than object finding and it is limited to radio frequency (RF) based techniques.

U.S. Pat. No. 6,759,958 “Method and apparatus for locating an object” by Hall—Uses light to sense transmitter and then activate an alarm. In addition to not possessing the flexibility of the present invention it also is highly limited to those situations in which light can be transmitted (either directly or via reflections) from the transmitter to the receiver. Often lost objects can be placed in places where little to no light is available such as in the crevice in a couch.

U.S. patent application Ser. No. 11/211,934 “Rechargeable Battery Assembly” by Daniel et al. shows a novel tie in of the USB computer interface system as the charging plug to a battery cell where the charge regulation circuitry is embedded in the battery. However while this gives the battery the ability to negotiate with the computer to charge, it does not provide the battery with the intelligence to be found or located as is shown in the present invention.

### RELATED APPLICATIONS

This application claims priority to U.S. provisional Patent Application Ser. No. 60/910,636, which was filed on Apr. 6, 2007. This application is incorporated entirely by reference.

### OBJECTS AND ADVANTAGES

The present invention provides several advantages over existing art. By integrating the object finding circuits in to a battery this allows consumers to move the findable batteries from device to device. This gives the user control over which devices to enable the finding functionality. For parents with small children this allows commonly lost toys to become findable and to enable new applications such as making sure no toy is left behind when visiting a friend or relatives house. Also for some devices such as flashlights, it can become convenient to find them in the dark, such as in a power outage, and this gives consumers the ability to put the object location technology in to such devices at their own convenience.

The present invention also has the ability to “pair” or assign a given battery to a certain class or number. Depending on the implementation this may show up as an icon or a text based identifier, or as number on the configuration device of a transmitter during the pairing process. By assigning different classes to different physical batteries the user can locate different devices individually.

### LIST OF FIGURES

FIG. 1 depicts a basic version of the invention.

FIG. 2 depicts both transmitter and receiver portions of the invention.

FIG. 3 shows different battery classes in use.

FIG. 4 shows an RF embodiment

FIG. 5 shows an sonic embodiment of the invention.

### DESCRIPTION OF THE INVENTION

The present invention combines a standard battery, such as the AAA sized battery commonly found in a remote control unit for a video system and object location device such as are sometimes used to control lights or to find keys and other objects in to a single product. This “Find Me Battery” product is then used to power consumer devices and can be used to find them when they are misplaced. In addition the present invention provides a mechanism by which such Find Me Batteries can be grouped so that different Find Me Batteries are assigned to different classes. This allows a user of the system to find objects (containing said batteries) of only a given class at a time greatly increasing the versatility of the invention.

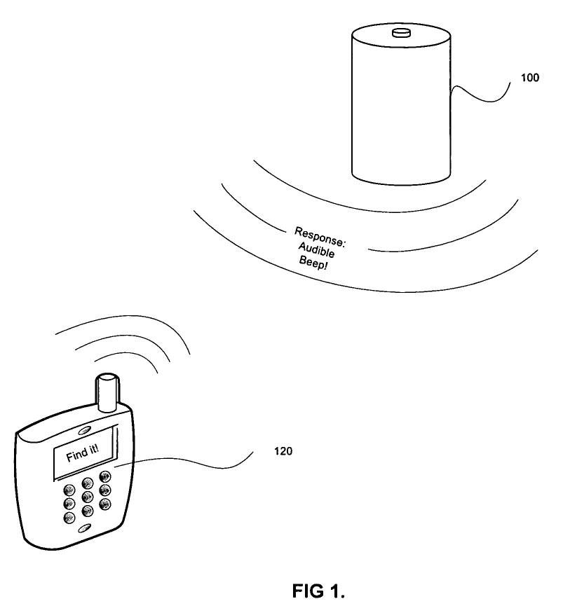

FIG. 1 depicts the present invention in general use without the battery being inside of a consumer electronics device. A transmitter (120) sends a signal to a battery equipped with the present invention (100) which can then send an audible signal so that the battery can be found.

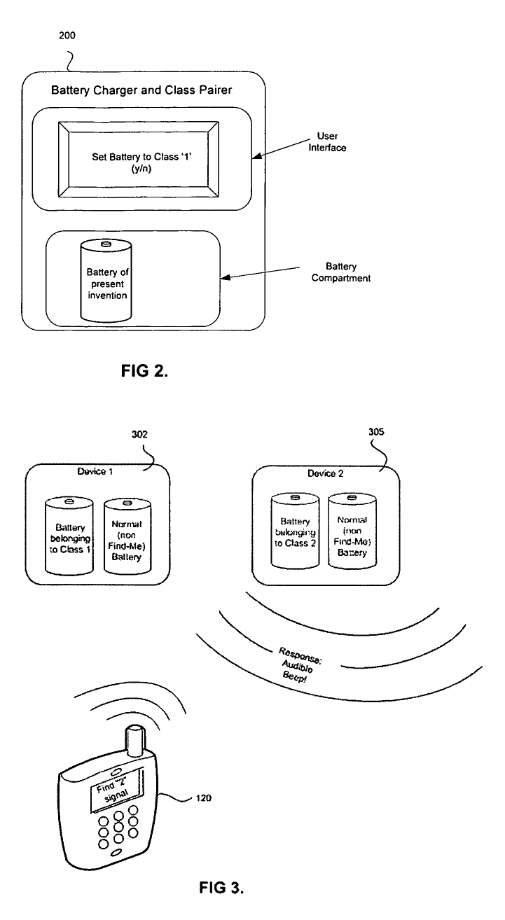

FIG. 2 depicts an embodiment of the system where a transmitting device is used to charge the battery with the receiver installed. The transmitter can also assign classes to the battery so that it can be selectively found.

FIG. 3 depicts and example embodiment showing two different devices, Device 1 (302) and device 2 (305). When the “find me #2” signal is emitted from a transmitter (120) then only the batteries with the class #2 pairing respond with a beep.

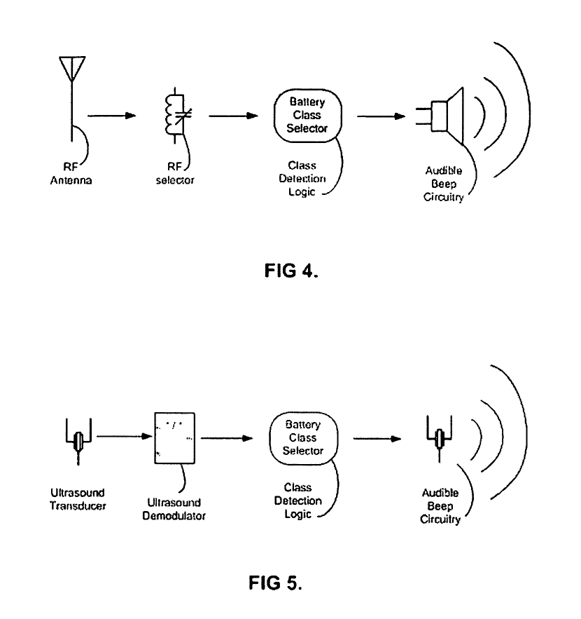

FIG. 4 depicts an embodiment of the receiver unit block diagram which is embedded in the battery. An RF antenna can be part of the battery casing or a separate antenna inside the battery provided that portions of the battery casing are made of RF transparent materials. This is then filtered and demodulated by a circuit which outputs the class of the transmitted signal. A class selector circuit then compares the demodulated signal to that of the class for that particular battery and if they match then the alarm is activated.

FIG. 5 is another embodiment of the receiver circuit in the battery with an ultrasound detection method employed. Note that the ultrasound receiver and transmitter can be directly coupled to the battery housing whereby the battery housing can mechanically amplify both the received acoustic signal and the sent acoustic signal.

An alternate method of assigning batteries to classes is to assign each battery a unique identification number. Then, when put in the pairing/transmitting device the transmitter learns this battery's number. When it is necessary to find that particular battery the identification number is modulated as part of the “find me” signal. When the battery senses the signal it demodulates it and determines if it was the battery called and if so sounds it's alarm.

What is claimed is:

1. A system for locating objects where a receiver circuit is located inside a battery cell and an attached alarm circuit which emits an alert sound to assist a user in finding the location of the battery when a transmitting signal is received.

2. A system as in claim 1 where said receiver circuit uses sound waves as the signaling medium.

3. A system as in claim 1 where said receiver circuit uses electromagnetic waves as the signaling medium.

4. A system as in claim 1 where said system allows different cells to be assigned different classes so that a transmitting device can activate only a certain set of the cells to respond to a find request signal.

5. A system as in claim 1 where said battery cell is A, AA, AAA, C, D, or “9V rectangular sized”.

6. A system as in claim 1 where said battery is a rechargeable type.

7. A system as in claim 1 where said alert sound can be used to also tell the charge status of the battery.

8. An alert sound as in claim 7 where said charge status is represented by the number of beeps in the alert sound.

9. An alarm circuit as in claim 1 which transmits an RF signal back to the transmitter so that the transmitter can display information about the battery.

10. An alarm circuit as in claim 1 transmits an ultrasound signal back to the transmitter so that the transmitter can display information about the battery.

11. A system of claim 1 where the different classes of batteries is pre-assigned at the factory.

12. A system of claim 1 where batteries connected in series or parallel can communicate with each other to synchronize their response back to a received transmitting signal so that multiple user level acknowledgements are avoided for batteries in the same physical device.

13. A system for finding consumer electronics devices in which a receiver is embedded in a battery which contains a uniquely assigned identification number and a transmitter can emit a signal which contains said identification number causing the battery to emit an alert.

14. A system of claim 13 in which the battery communicates back to the transmitter information about its status.

15. A system of claim 13 in which the battery gives an audible alert about its status when its identification number matches the number in the transmitter's signal.
